(19) United States
(12) Patent Application Publication
(10) Pub. No.: US 2001/0034702 A1
(43) Pub. Date: Oct. 25, 2001

(54) System and method for dynamically issuing and processing transaction specific digital credit or debit cards

(76) Inventors: Gregory P. Mockett, Spanish Fork, UT (US); David Wingate, Provo, UT (US)

Correspondence Address: TRASK BRITT, P.O. BOX 2550, SALT LAKE CITY, UT, 84110, US

(21) Appl. No.: 09/777,723

(22) Filed: Feb. 5, 2001

Related U.S. Application Data
(60) Provisional application No. 60/180,329, filed on Feb. 4, 2000.

(51) Int. Cl. G06F 17/60

(52) U.S. Cl. 705/39; 705/26

(57) ABSTRACT

A system and method of dynamically issuing credit card numbers and processing transactions using those credit card numbers is disclosed. A method according to the invention includes digitally recognizing a transaction opportunity on the Internet in real-time, recognizing the terms of the transaction, linking a dynamic digital credit card issuing apparatus directly into a qualified credit card issuing host, generating a partially random digital credit card number, logging the transaction, checking the terms of the transaction for acceptance, passing the dynamically issued digital credit card number to the merchant, processing the digital credit card number through the merchant's card processing system, receiving the transaction approval request, participating in credit card validity checking systems, processing the approval request in real-time, sending the requesting party a legitimate authorization code, and retiring the digital credit card number immediately upon transaction approval or disapproval. A system according to the invention implements the method of the invention.

### PRIORITY CLAIM

This patent application claims the benefit of the filing date of U.S. Provisional Patent Application Ser. No. 60/180,329, filed Feb. 4, 2000, for “SYSTEM AND METHOD FOR DYNAMICALLY ISSUING AND PROCESSING TRANSACTION SPECIFIC DIGITAL CREDIT OR DEBIT CARDS”. This patent application is related to copending utility patent application for “SYSTEM AND METHOD FOR A SERVER-SIDE BROWSER INCLUDING MARKUP LANGUAGE GRAPHICAL USER INTERFACE, DYNAMIC MARKUP LANGUAGE REWRITER ENGINE AND PROFILE ENGINE”, filed Feb. 5, 2001, attorney docket number, 2741-4289.1US.

### TECHNICAL FIELD

This invention relates generally to e-commerce and monetary transactions. In particular, the invention relates to a system and method for dynamically issuing digital credit card numbers.

### BACKGROUND ART

The growth of online transactions for goods and services, or e-commerce, has paralleled the growth of the Internet. Currently, it is routine for a customer to perform an online search for an item or service, perhaps with unique characteristics, or perhaps for lowest price. Once identified, the customer may decide to purchase the item or service. Methods for purchasing may include filling out and/or printing a form identifying the item or service and providing payment. Payment options vary from the conventional mailing of a check, to providing a credit or debit card number with proper identifying information.

The use of a credit or debit card is preferred by buyers because of the convenience of using such a card and quick approval for executing the transaction. Vendors, while generally unhappy with the premium paid to the merchant bank (generally a few percent of the total transaction), can more quickly ascertain whether payment is forthcoming (through the credit card transaction authorization process) and provide access to customers that require payment by credit card. Some vendors require a personal check to clear the bank deposit process before shipping an item or providing a service associated with a transaction. This is inconvenient to both the buyer and the vendor. Cash or currency, while convenient for many in-person transactions, has obvious limitations in the online transaction context.

In the emerging e-commerce driven economy, where realtime transactions are becoming more of a norm than an exception, it becomes possible and highly desirable to dynamically create transaction-unique or balance-specific credit card numbers on demand from an intermediary server-side computer or process. Such transactions would eliminate credit card theft, whether from a sniffer (hardware and/or software that detects a 16 digit credit card string in a packet at a router or from keyboard strokes), server hacking, cookies swiping, and the like. Additionally, such transaction-unique credit card numbers would facilitate universal gift cards, allow for controlled-limit credit for employees or minors and facilitate anonymous online transactions. Use of an intermediary entity server computer to facilitate such transaction-unique credit card numbers is desirable for ensuring security, privacy and for facilitating post sale transactions.

### DISCLOSURE OF INVENTION

A system and process for dynamically issuing and processing a transaction-specific digital credit card for use in secure, anonymous online transaction is disclosed herein. The present invention includes assessing a current transaction in realtime over a network involving at least one merchant computer, one buyer computer, and one intermediary computer. A digital credit card is then dynamically created and issued where the first set of prefix digits represent or identify a depository bank or host prefix to permit operation within the established credit card approval system. The remaining suffix digits are randomly generated and unique to the then current transaction. The digital credit card account carries an actual account balance. The account balance may, or may not, be communicated to the merchant involved in the given transaction or transactions. The merchant then processes the transaction specific digital credit card as any other credit card.

A method embodiment, in accordance with the present invention, for processing a transaction over the Internet in realtime includes identifying an opportunity for a transaction between a buyer and a seller on the Internet in realtime and ascertaining the terms of the transaction linking a dynamic digital credit card issuing apparatus directly into a qualified credit card issuing host computer. The method embodiment further includes generating a unique, partially-random, digital credit card number, logging the transaction, checking the terms of the transaction for acceptance and passing the digital credit card number to the seller. The method also includes processing the digital credit card number through a seller's credit card processing system and retiring the digital credit card number upon the occurrence of the transaction approval or disapproval. A record of the transaction is maintained for a period of time inclusive of settlement.

In accordance with the present invention, a system embodiment for processing a transaction over a network in realtime includes a merchant computer for providing goods and services online and configured to accept credit cards as a primary means of payment acceptance, a merchant bank associated with the merchant and configured for processing credit card approvals on behalf of the merchant and a user computer configured with a client-side browser configured for communication over the network. The system also includes a depository bank configured for communication with the user computer and including a repository of funds and a host computer associated with a credit card issuing entity and configured for communication with the depository bank and configured to receive credit card approval requests from a merchant bank. The system further includes a credit card approval network for approving a credit card transaction between a merchant bank and said host computer, a intermediary server computer configured for communication with the user computer for receiving input from the user computer, a dynamic credit card issuer (DCCI) configured for communication with the host computer and the intermediary server computer for dynamically generating a partially-random digital credit card number. The system further includes an automated clearing house settlement process configured for communication between the depository bank and the merchant bank for processing payments there between.

Another method embodiment, in accordance with the present invention, for digitally recognizing an online transaction opportunity in realtime includes providing a server-side browser hosted on a server in communication with the Internet, the server-side browser configured for performing client Internet browser functions from the server and capturing a buyer's Internet surfing experience including a merchant's web pages. The method further includes dynamically rewriting content from the merchant's web pages to provide new methods of interacting with the dynamically rewritten content without changing layout or content of the merchant's web pages and capturing a buyer's input in response to the dynamically rewritten content.

An apparatus embodiment, in accordance with the present invention, for dynamically issuing a digital credit card number includes an intermediary computer configured for communication over a packet-based network, a process running on the intermediary computer configured for issuing a transaction specific debit or credit card number, the number comprising a number representative of a debit or credit card account, a prefix of the number representative of a debit or credit card issuing entity, and a suffix of the number representative of a randomly generated number.

In accordance with the present invention, a computer system embodiment configured for communication over a packet-based network and programmed to implement a method for processing e-commerce transactions, is also disclosed.

These embodiments and methods of the present invention will be readily understood by reading the following detailed description in conjunction with the accompanying figures of the drawings.

### BRIEF DESCRIPTION OF DRAWINGS

In the drawings, which illustrate what is currently regarded as the best mode for carrying out the invention and in which like reference numerals refer to like parts in different views or embodiments:

FIG. 1 is a block diagram of a system for dynamically issuing and processing digital credit card numbers for implementing transactions according to the invention.

FIG. 2 is a flow diagram of a method for dynamically issuing and processing digital credit card numbers for implementing transactions according to the invention.

### BEST MODES FOR CARRYING OUT THE INVENTION

A system and process for dynamically issuing and processing a transaction specific digital credit card for use in a secure, anonymous online transaction is disclosed herein. A method according to the invention includes digitally recognizing a transaction opportunity on the Internet in realtime, recognizing the terms of the transaction and linking a dynamic digital credit card issuing apparatus directly into a qualified credit card issuing host. The method further includes generating a unique partially random digital credit card number, logging the transaction, optionally, pre-authorizing a user, checking the terms of the transaction for acceptance, passing the dynamically issued digital credit card number to the merchant, processing the digital credit card number through the merchant's card processing system, receiving the transaction approval request, participating in credit card validity checking systems, processing the approval request in realtime, sending the requesting party a legitimate authorization code, and retiring the digital credit card number when the transaction is approved or disapproved. A record of the transaction may be maintained for a period of time inclusive of settlement.

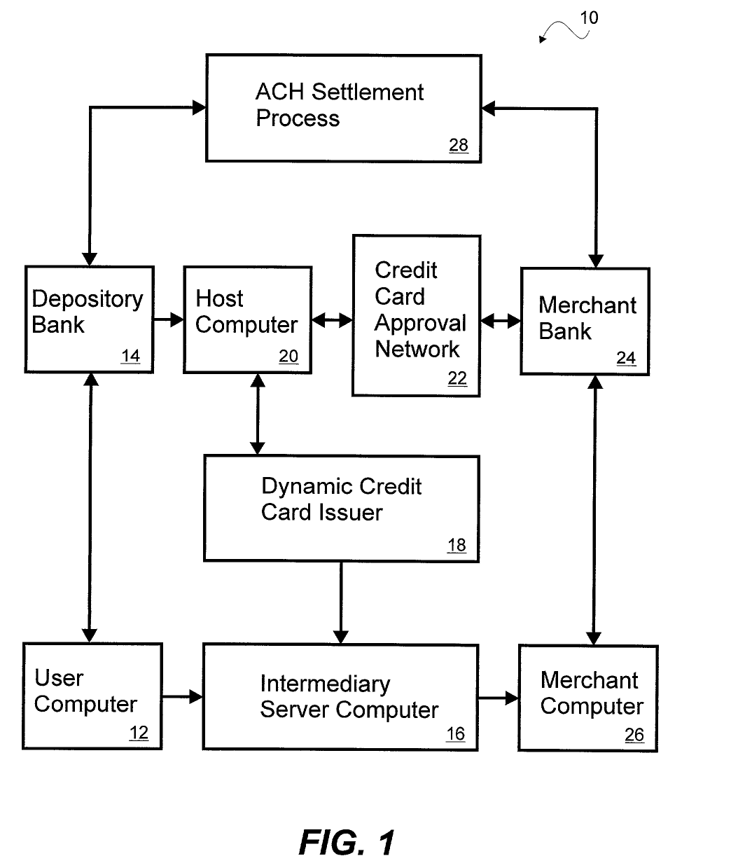

FIG. 1 illustrates a block diagram of a system according to the invention. The system 10 according to the invention may include a user computer 12, at least one depository bank 14, a intermediary server computer 16, a dynamic credit card issuer (DCCI) 18, a host computer 20, a credit card approval network 22, at least one merchant bank 24, at least one merchant computer 26 and an automated clearing house (ACH) settlement process 28. User computer 12 has an Internet connection or at least the ability to communicate with the Internet. User computer 12 may be any kind of computer from which a user may establish an Internet connection using client-side browser (CSB) software. An intermediary entity may control the intermediary server computer 16. Alternatively, an intermediary entity may control intermediary server computer 16 and DCCI 18. It is also possible that an intermediary entity may control intermediary server computer 16, DCCI 18, depository bank 14 and host computer 20 or any combination thereof. The terms “user” and “buyer” are used interchangeably herein to denote a person acquiring goods or services from a merchant in an e-commerce transaction in accordance with the present invention.

Depository bank 14 is a repository for finds sent to one or more intermediary entity bank accounts, usually via an electronic funds transfer or purchase of credits within an intermediary server computer 16. Depository bank 14 may include a computer configured to communicate over a packet-based network, such as the Internet. The intermediary server computer 16 receives input from a user and reviews or translates this input to initiate functions that might translate data, create a dynamic credit card account, etc., in accordance with the present invention. A user may pre-fund an account with the intermediary entity at the intermediary server computer 16. However, generally actual funds will remain at depository bank 14.

DCCI 18 communicates with the host computer 20 and the intermediary server computer 16. DCCI 18 is capable of verifying total funds available at the depository bank 14, assigning a credit available amount based on the total funds available at the depository bank 14. DCCI 18 is also configured to check the intermediary server computer's database that records account balance information in relation to a user's previous deposits/transactions, randomly generate an anonymous credit card number where the prefix of the number identifies a legitimate credit card issuing entity associated with host computer 20, and then receive a request for approval via the credit card approval network 22.

Host computer 20 communicates with depository bank 14, the credit card approval network 22, and DCCI 18. All credit card issuing entities must be hosts or be connected to host computers 20 in order to receive credit card approval requests from merchant bankers 24. In a preferred embodiment of system 10, the intermediary entity associated with the intermediary server computer 16 is also a credit card issuing entity.

Merchant computer 26 is associated with a merchant who is an online, E-commerce equipped, retailer (or in e-commerce parlance, an “e-tailer”) who accepts credit cards as a primary means of payment. The merchant also processes the fulfillment of the purchase, i.e., provides the goods or services being purchased. Merchant computer 26 may also be attached to an e-commerce gateway.

Credit card approval network 22 is the existing and conventional facility for approving credit cards between a merchant bank 24, and a credit card issuing entity and its host computer 20. Merchant bank 24 is the existing credit card approval processor for its associated merchant. Merchant bank 24 may also be a transaction gateway as part of an e-commerce infrastructure. Merchant bank 24, regardless of identity, is charged with taking transaction data and processing it to the right issuer/originator to validate and gain approval on each transaction. Merchant banks 24 also bear risks for settlement, which is a separate process if they guarantee immediate funds to their merchant clients.

The ACH settlement process 28 is the existing conventional facility for processing payments from bank to bank, as sponsored by the Federal Reserve. Generally, the minimum payment period is 72 hours and the maximum is 6 days to guarantee and validate delivery and receipt of funds.

Referring to FIG. 1, an exemplary transaction in accordance with the present invention is described. A user activates a CSB installed and running on user computer 12. The CSB may be a Web browser such as Internet Explorer™ (available from Microsoft Corporation, Redmond, Wash.) or any other Internet browser. The user addresses (or “browses” or “surfs”) a Web site at an intermediary server computer 16. The user logs into intermediary server computer 16. The user then makes a request of the intermediary server computer 16 for a merchant web site, i.e., the destination server computer of the merchant, or merchant computer 26. This request may simply constitute typing the network appellation of a particular Web site, i.e., the domain name, universal resource locator (URL), or IP address of a merchant's Web site or clicking on a link pointing to the particular Web site. The intermediary server computer 16 makes a request to the merchant computer 26 for the user-requested Web site or Web page. Intermediary server computer 16 rewrites the user-requested Web site or Web page and presents the rewritten Web site or Web page within a frame on a server-side browser loaded on the intermediary server computer 16.

The user may make various site requests via the intermediary server computer 16, as defined above, during the product and/or service discovery and selection process. If, for example, the user decides to purchase a particular item or “good” found during this discovery process, the user inputs various transaction information into the input fields of the rewritten destination server computer pages. This allows the intermediary server computer 16 to both “see” and “control” the use of the data prior to its being sent to the merchant computer 26. Macros like “CC” for credit card number may be entered and the intermediary computer 16 reads this as it is submitted by the user, then checks the login and may optionally validate the login. Intermediary server computer 16 then grabs any and all then-known transaction data, and makes a request from the DCCI 18 for a dynamic credit card account and number.

The DCCI 18, which may be a part of the intermediary server computer 16 or some other computer networked thereto, then checks data stored in a database on the intermediary server computer 16 to discover how much money the user has forwarded to an intermediary entity's account at the depository bank 14 and whether those funds have been confirmed by the ACH settlement process 28. DCCI 18 then checks the depository bank 14 to see whether the required funds, i.e., those funds necessary to complete the given transaction, are in the intermediary entity's account and generates a partially-random digital credit card number wherein, e.g., the number includes a prefix associated with a credit card issuing entity and a suffix representing a randomly generated number not presently active and live or otherwise being used in accordance with the present invention. DCCI 18 also generates an expiration and an actual attached value or purchasing limit and then passes the partially-random digital credit card number and other transaction data back to the intermediary server computer 16 for submission to the merchant computer 26. It is noted that this request for a dynamic credit card account number and transaction information and its subsequent translation into the correct fields within the return string to the destination site (merchant computer 26) occurs entirely automatically. That is, the request for a dynamic credit card account number and subsequent processing occurs without the interference, participation, control, or review of either the user or the merchant.

Merchant computer 26 receives the partially-random digital credit card number and processes it to its E-commerce gateway, merchant banker or even directly within the credit card approval network 22. A request is made of the host computer 20 directly or of the DCCI 18 indirectly for an approval code. The terms “approval code” and “authorization code” are used synonymously herein. The host computer 20 or the DCCI 18 checks the transaction information against the dynamic credit card account information, created moments before, to determine whether to process and return an approval code back to the merchant 26.

Upon approval or disapproval, the card number and account are immediately deactivated (or retired). However, a record of the number and transaction data are maintained for a period of time inclusive of settlement for tracking the settlement of that particular transaction. If approval is not granted, the account is immediately deleted. In either case, an appropriate notation accounting adjustment takes place in a database on the intermediary server computer 16 to reflect whether the transaction took place or not. If a transaction did take place, a final notation is made in the database upon settlement.

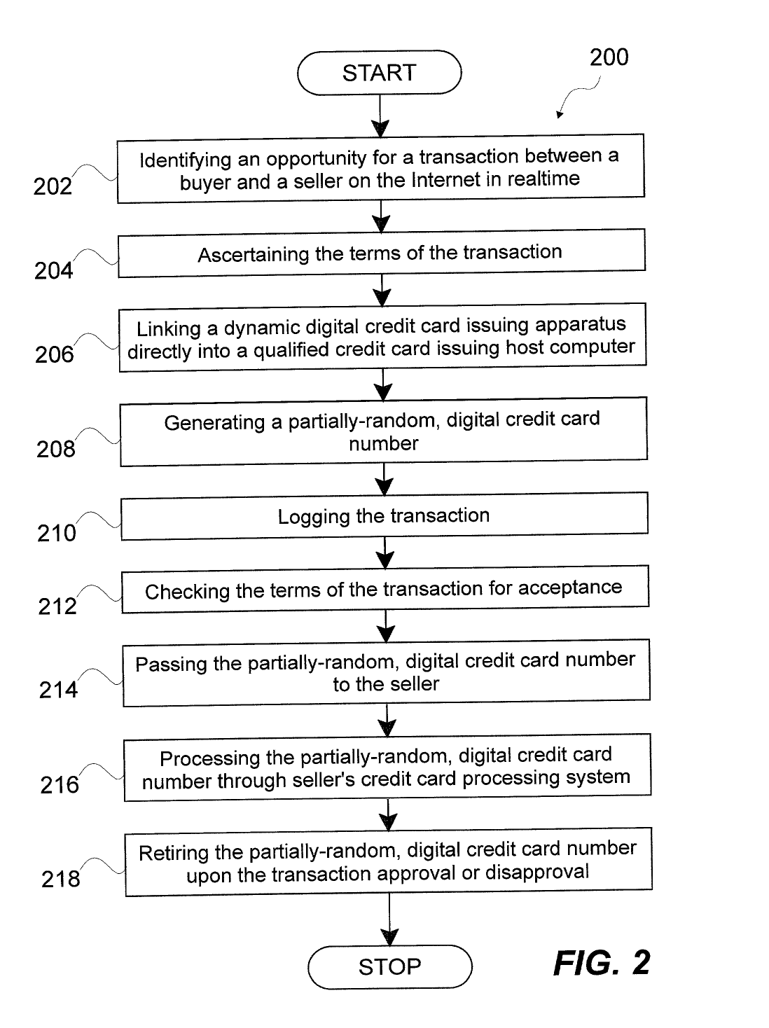

Referring to FIG. 2, a flow diagram of a method 200 for dynamically issuing and processing digital credit card numbers for implementing transactions according to the invention is shown. Method 200 includes identifying 202 an opportunity for a transaction between a buyer and a seller over a packet-based network (e.g., the Internet) in realtime and ascertaining 204 the terms of the identified transaction. Method 200 also includes linking 206 a dynamic digital credit card issuing apparatus directly into a qualified credit card issuing host computer, generating 208 a unique, partially-random, digital credit card number and logging 210 the transaction. Method 200 also includes checking 212 the terms of the transaction for acceptance, passing 214 the unique, partially-random, digital credit card number to the seller, processing 216 the unique credit card number through the seller's credit card processing system, and retiring 218 the unique credit card number immediately upon the occurrence of transaction approval or disapproval. A record of the transaction may be maintained for a period of time inclusive of settlement.

Although this invention has been described with reference to particular embodiments, the invention is not limited to these described embodiments. Rather, it should be understood that the embodiments described herein are merely exemplary and that a person skilled in the art may make many variations and modifications without departing from the spirit and scope of the invention. All such variations and modifications are intended to be included within the scope of the invention as defined in the appended claims.

What is claimed is:

1. A method for processing a transaction over the Internet in realtime, comprising:
identifying an opportunity for a transaction between a buyer and a seller on the Internet in realtime;
ascertaining terms of said transaction;
linking a dynamic digital credit card issuing apparatus directly into a qualified credit card issuing host computer;
generating a unique, partially-random, digital credit card number;
logging said transaction;
checking said terms of said transaction for acceptance;
passing said digital credit card number to said seller;
processing said digital credit card number through seller's credit card processing system; and
retiring said digital credit card number upon the occurrence of transaction approval or disapproval.

2. The method of claim 1, wherein said generating a unique, partially-random, digital credit card number further comprises generating a 16 digit credit card number, wherein a prefix of 4 digits of said 16 digit credit card number identify an issuer and a suffix of 12 digits of said 16 digit credit card number comprise a randomly generated number.

3. The method of claim 1, wherein said processing said digital credit card number through seller's credit card processing system comprises:
participating in credit card validity checking systems;
initiating a transaction approval request;
processing said approval request in realtime; and
obtaining transaction approval.

4. The method of claim 3, wherein said obtaining transaction approval comprises providing said seller with an authorization code.

5. A system for processing a transaction over a network in realtime, comprising:
a merchant computer associated with a merchant for providing goods and services online and configured to accept credit cards as a primary means of payment;
a merchant bank configured for communication with said merchant computer configured for processing credit cards approvals on behalf of said merchant;
a user computer with a client-side browser configured for communication over said network;
a depository bank configured for communication with said user computer and comprising a repository of funds;
a host computer associated with a credit card issuing entity, configured for communication with said depository bank, and configured to receive credit card approval requests from a merchant bank;
a credit card approval network for approving a credit card transaction between a merchant bank and said host computer;
an intermediary server computer configured for communication with said user computer and for receiving input from said user computer;
a dynamic credit card issuer (DCCI) configured for communication with said host computer and said intermediary server computer and for dynamically generating a partially-random digital credit card number; and
an automated clearing house settlement process configured for communication between said depository bank and said merchant bank for processing payments there between.

6. The system of claim 5, wherein said intermediary server computer comprises a database for recording account balance information associated with a user, and is configured for reviewing said input received from said user computer and translating said input to initiate functions.

7. The system of claim 6, wherein said functions comprise translating data received from said input.

8. The system of claim 6, wherein said functions comprise creating a dynamic credit card account.

9. The system of claim 5, wherein said DCCI comprises a computer configured for:
verifying credits in a database representing funds available at a depository bank for completing a transaction;
assigning a credit available amount based upon said funds available;
checking said database for a history of deposits and transactions associated with said user;
generating said partially-random digital credit card number comprising a prefix of 4 digits associated with a credit card issuer and a suffix of 12 digits comprising a randomly generated number;
receiving a request for approval from said credit card approval network; and
sending an approval code to authorize said transaction.

10. The system of claim 9, wherein said DCCI comprises hardware and software, and is resident on or networked to said host computer and configured for electronic connection to said credit card approval network for effecting a transaction approval.

11. A method for digitally recognizing an online transaction opportunity in realtime, comprising:
providing a server-side browser hosted on a server in communication with an Internet, said server-side browser configured for performing client Internet browser functions from said server;
capturing content from a merchant's Web pages accessed by a buyer;
dynamically rewriting said content to provide additional functionality to said dynamically rewritten content without changing layout or content of said merchant's web pages; and
capturing a buyer's input in response to said dynamically rewritten content.

12. The method of claim 11, wherein said capturing a buyer's input comprises presenting to said buyer various form elements from said dynamically rewritten content and capturing input from said buyer in said various form elements.

13. The method of claim 12, wherein said input from said buyer comprises a macro.

14. The method of claim 11, further comprising:
analyzing said buyer's input;
optionally translating said buyer's input; and
communicating said buyer's input or said optionally translated buyer's input to a merchant computer for some part or all of a transaction request.

15. The method of claim 14, wherein said optionally translated buyer's input is encrypted.

16. The method of claim 11, further comprising capturing information from a buyer during a user verification process prior to initiating a transaction to verify who said buyer is.

17. An apparatus for dynamically issuing a digital credit card number comprising:
an intermediary computer configured for communication over a packet-based network;
a process running on said intermediary computer configured for issuing a transaction specific debit or credit card number, said number comprising:
a number representative of a debit or credit card account;
a prefix of said number representative of a debit or credit card issuing entity; and
a suffix of said number representative of a randomly generated number.

18. The apparatus of claim 17, wherein said prefix comprises a 4 digit number.

19. The apparatus of claim 17, wherein said suffix comprises a 12 digit number.

20. The apparatus of claim 17, wherein said intermediary computer receives a macro and then interprets said macro as a request for a credit card number.

21. The apparatus of claim 17, wherein said intermediary computer receives a macro and then interprets said macro as a request for a portion of transaction data, said portion including expiration date, name of cardholder and billing address of said cardholder.

22. The apparatus of claim 17, wherein said intermediary computer is configured to randomly generate a fictitious address, user name, or portions thereof for a given transaction and log same as a part of the transaction data.

23. The apparatus of claim 17, wherein said intermediary computer is configured for checking a login database for confirmation that a user is qualified to use said apparatus to effect a transaction.

24. A computer system configured for communication over a packet-based network and programmed to implement a method for processing e-commerce transactions, said method comprising:
ascertaining a balance associated with a buyer based on funds available in one or more accounts of said buyer or funds guaranteed on behalf of said buyer, wherein said balance may be determined in realtime and is attachable by said intermediary computer to effect an e-commerce transaction;
transferring at least a portion of said balance to a transaction specific credit or debit card account;
creating a transaction-specific credit card number associated with said transaction specific credit or debit card account by affixing a random set of suffix digits to a host-assigned set of prefix digits; and
logging said transaction-specific credit card number as active for use in completing said e-commerce transaction.

25. The computer system of claim 24, wherein said balance may be used as a continue/discontinue criterion for proceeding with issuance of said transaction specific credit card number.

26. The computer system of claim 24, wherein said transferring at least a portion of said balance comprises optionally applying an exchange rate to affix values in a specific currency.

27. The computer system of claim 24, wherein creating a transaction-specific credit card number further comprises checking a database to ensure that no identical number is presently in approval or settlement processes running on said computer system or been permanently retired by said computer system.

28. The computer system of claim 24, wherein said method further comprises passing said transaction-specific credit card number directly to a merchant computer without sending or displaying said number to said buyer.

29. The computer system of claim 24, wherein said method further comprises logging and/or linking all previously known buyer data, transaction data and merchant data associated with said transaction-specific credit card number.

30. The computer system of claim 24, wherein said method further comprises:
comparing a credit card number from a merchant's approval request with a list of issued and active transaction-specific credit card numbers; and
processing said approval request according to a conventional credit card approval process.

31. The computer system of claim 30, wherein said method further comprises:
returning an authorization code in response to said merchant's approval request;
logging said authorization code as part of a transaction-specific digital credit or debit card account record;
instituting an automated clearing house or direct account settlement process;
expiring said transaction-specific credit card number immediately upon returning said authorization code or upon disapproval;
retiring said random set of suffix digits for a period of time;
archiving transaction data; and
returning said retired random set of suffix digits to circulation within said computer system.

32. The computer system of claim 24, wherein said balance is adjusted by an approved transaction amount.
